(19) United States
(12) Patent Application Publication
(10) Pub. No.: US 2010/0308677 A1
(43) Pub. Date: Dec. 9, 2010

(54) ROTOR SPINDLE STRUCTURE

(76) Inventor: Ming-Hung HSIEH, Taichung City (TW)

Correspondence Address: Guice Patents PLLC, 12647 Galveston Court #302, Manassas, VA, 20112, US

(21) Appl. No.: 12/478,887

(22) Filed: Jun. 5, 2009

(51) Int. Cl. H02K 1/28

(52) U.S. Cl. 310/156.08

(57) ABSTRACT

A rotor spindle structure including a spindle with a predetermined length and a coupling section integrally formed on the spindle. The coupling section has an extension portion radially outward extending from a circumference of the spindle by a predetermined length. The coupling section further has an annular coupling face formed on a rim of the extension portion. The coupling face is parallel to the axis of the spindle and the center of curvature of the coupling face coincides with the axis of the spindle.

### BACKGROUND OF THE INVENTION

The present invention is related to a motor, and more particularly to an improved rotor spindle structure.

FIGS. 1 and 2 show a conventional inner rotor torque motor 1. The rotor of the torque motor 1 will rotate under magnetic force to output mechanical power via a spindle. Such technique pertains to well known prior art. However, some defects still exist in such torque motor.

To speak more specifically, the spindle 3 has an outer diameter not in conformity with the inner diameter of the rotor ring 2 of the rotor. Therefore, it is necessary to couple the spindle 3 with the rotor ring 2 with a bridge component. As shown in FIGS. 1 and 2, an end ring 4 is coaxially fixedly connected with the spindle 3. The end ring 4 is attached to and coupled with an end of the rotor ring 2. Accordingly, the spindle 3 is coaxially extended into the rotor ring 2 and coupled with the rotor ring 2 via the end ring 4. The kinetic energy of the rotor is first transmitted to the spindle 3 via the end ring 4 and then output to a driven object from the spindle 3.

Such power transmission structure is composed of many separate components, which are assembled with each other. Therefore, the tolerances existing in the respective components will sum up to result in that the center of curvature of the rotor 2 deviates from the axis of the spindle 3. Moreover, the kinetic power is indirectly transmitted via the separate end ring. In this case, the connection components such as bolts may break under greater torque due to poor quality. This will interrupt power transmission and shorten lifetime of the motor.

### SUMMARY OF THE INVENTION

It is therefore a primary object of the present invention to provide an improved rotor spindle structure, which is directly coupled with the rotor ring without using any separate component. Therefore, the rotor spindle structure is free from any summed up tolerance to ensure that the spindle is coaxially coupled with the rotor with the center of curvature of the rotor coincides with the axis of the spindle.

It is a further object of the present invention to provide the above rotor spindle structure by which the rotational kinetic energy of the rotor can be directly transmitted to the spindle without deterioration due to additional retainer components.

To achieve the above and other objects, the rotor spindle structure of the present invention includes a spindle with a predetermined length and a coupling section integrally formed on the spindle. The coupling section has an extension portion radially outward extending from a circumference of the spindle by a predetermined length. The coupling section further has an annular coupling face formed on a rim of the extension portion. The coupling face is parallel to the axis of the spindle and the center of curvature of the coupling face coincides with the axis of the spindle.

The present invention can be best understood through the following description and accompanying drawings wherein:

### BRIEF DESCRIPTION OF THE DRAWINGS

FIG. 1 is a perspective exploded view of a conventional inner rotor torque motor;

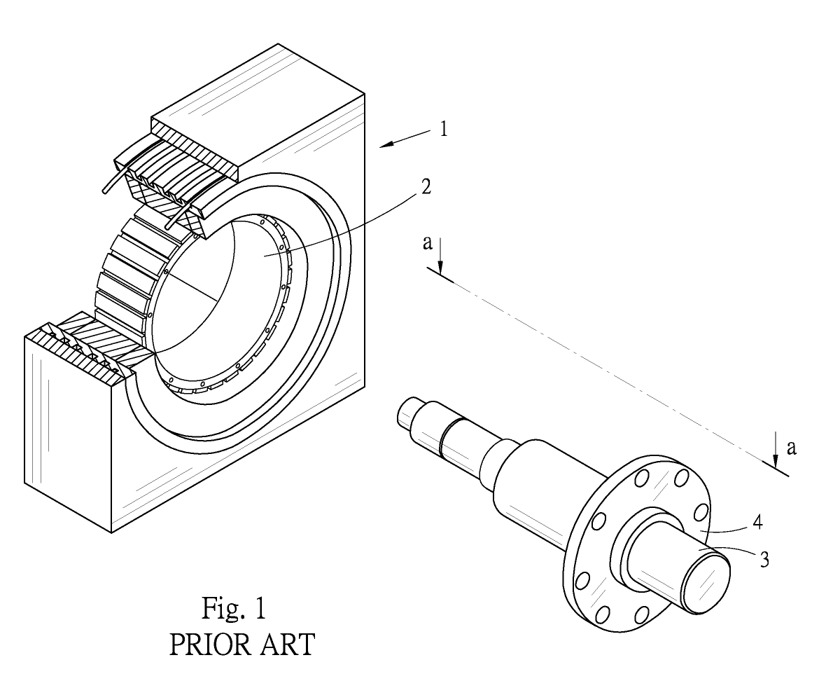

FIG. 2 is a sectional view taken along line a-a of FIG. 1;

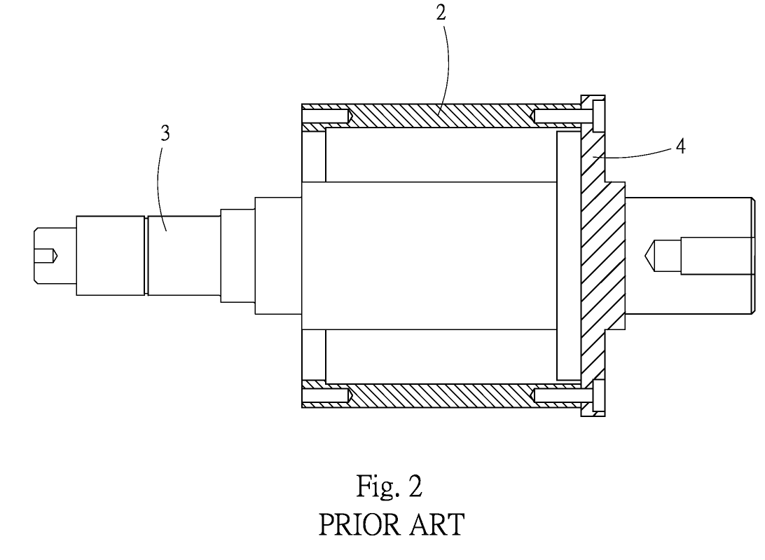

FIG. 3 is a perspective view of a preferred embodiment of the rotor spindle structure of the present invention; and

FIG. 4 is a sectional view taken along line b-b of FIG. 3.

### DETAILED DESCRIPTION OF THE PREFERRED EMBODIMENT

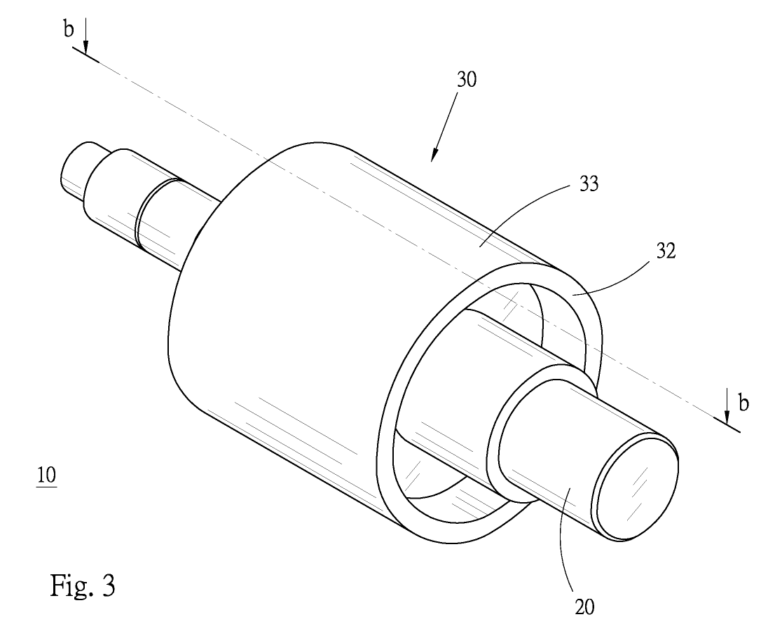

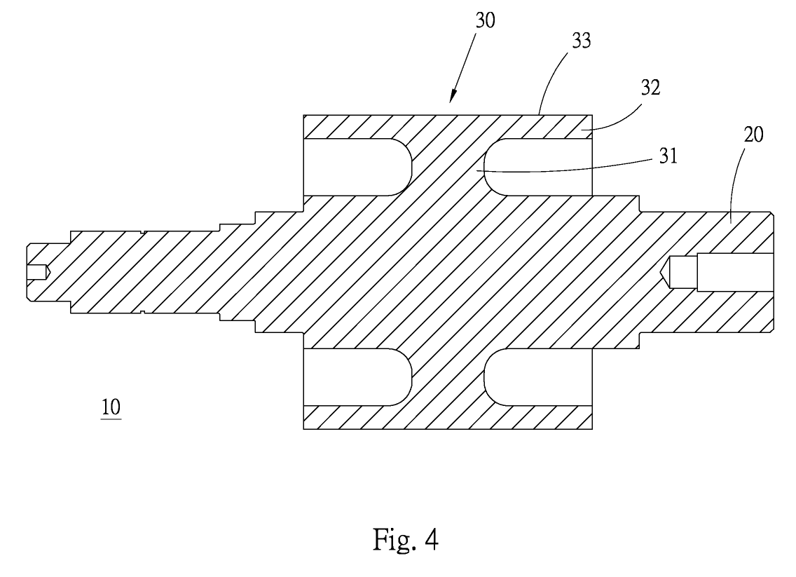

Please refer to FIGS. 3 and 4. According to a preferred embodiment, the rotor spindle structure 10 of the present invention includes a spindle 20 and a coupling section 30 integrally formed on the spindle 20. The spindle 20 is a solid rod body with a certain length. The outer circumference of spindle 20 is stepped to have different diameters for connecting with an external transmission component. This pertains to prior art and is not included in the scope of the present invention and thus will not be further described hereinafter.

The coupling section 30 and the spindle 20 are integrally formed by means of an integral molding method such as forging, casting or metal die-casting. The coupling section 30 has an annular extension portion 31 radially outward extending from a circumference of the middle of the spindle 20 by a certain length. The coupling section 30 further has an axially straightly extending coupling tube 32, which is fixedly connected with a rim of the extension portion 31. The coupling tube 32 has an axis coinciding with the axis of the spindle 20. The coupling tube 32 has an outer diameter substantially equal to an inner diameter of a rotor ring in which the coupling tube 32 is fitted. The coupling tube 32 has an outer circumference serving as an annular coupling face 33. The center of curvature of the coupling face 33 coincides with the axis of the spindle 20.

According to the above arrangement, the rotor spindle structure 10 can be directly coaxially serially connected with the rotor ring of an inner rotor motor by way of tight fit. Accordingly, the mechanism power of the motor can be output from the spindle 20. Such connection measure is free from any additional retainer component and thus is simpler than the prior art.

The coupling section 30 is integrally formed on the spindle 20 without assembling any component as in the prior art. Therefore, the rotor spindle structure 10 of the present invention is free from any summed up error derived from the errors in the assembling process. Accordingly, the dimensional precision can be ensured. When the rotor spindle structure 10 is assembled with the rotor of the inner rotor motor, it can be ensured that the axis of the spindle 20 coincides with the center of curvature of the motor rotor. In this case, the motor can stably output power. Moreover, the coupling tube 32 of the coupling section 30 is coaxially connected with the rotor ring of the motor by way of tight fit so that the kinetic energy of the rotor can be directly transmitted to the spindle 20, which is integrally connected with the coupling section 30. In contrast, in prior art, the power of the rotor is transmitted through numerous separable components, which are assembled with each other. These components are likely to damage in the power transmission process to shorten lifetime of the motor. Therefore, with the rotor spindle structure 10 of the present invention, the lifetime of the motor can be prolonged to achieve economic benefit.

It should be noted that the rotor spindle structure 10 of the present invention is not only applicable to an inner rotor motor, but also applicable to an outer rotor motor or any other compatible type of motor. The above embodiment is only for illustration purposes only, not intended to limit the scope of the present invention. Many modifications of the above embodiments can be made without departing from the spirit of the present invention.

What is claimed is:

1. A rotor spindle structure comprising:
a spindle having a predetermined length; and
a coupling section integrally formed on the spindle, the coupling section having an extension portion radially outward extending from a circumference of the spindle by a certain length, an annular coupling face being formed on a rim of the extension portion in parallel to an axis of the spindle, the center of curvature of the coupling face coinciding with the axis of the spindle.

2. The rotor spindle structure as claimed in claim 1, wherein the coupling section further has a coupling tube, which is fixedly connected with the rim of the extension portion, the coupling tube having an axis coinciding with the axis of the spindle, the coupling tube having an outer circumference serving as the annular coupling face.
